(19) United States
(12) Patent Application Publication
(10) Pub. No.: US 2023/0069089 A1
(43) Pub. Date: Mar. 2, 2023

(54) VIDEO DECODER WITH HARDWARE SHARED BETWEEN DIFFERENT PROCESSING CIRCUITS AND ASSOCIATED VIDEO DECODING METHOD

(71) Applicant: MEDIATEK INC., Hsin-Chu (TW)

(72) Inventors: Chien-Wei Lin, Hsinchu City (TW); Meng-Jye Hu, Hsinchu City (TW)

(73) Assignee: MEDIATEK INC., Hsin-Chu (TW)

(21) Appl. No.: 17/837,071

(22) Filed: Jun. 10, 2022

Related U.S. Application Data
(60) Provisional application No. 63/238,859, filed on Aug. 31, 2021.

(51) Int. Cl. H04N 19/44; H04N 19/176; H04N 19/132; H04N 19/423; H04N 19/593; H04N 19/33; H04N 19/186; H04N 19/127

(52) U.S. Cl. CPC H04N 19/44; H04N 19/176; H04N 19/132; H04N 19/423; H04N 19/593; H04N 19/33; H04N 19/186; H04N 19/127

(57) ABSTRACT

A video decoder has a plurality of processing circuits, including a first processing circuit and a second processing circuit. The first processing circuit applies a first decoding process to a current coding block according to reconstructed neighbor samples, and has a local neighbor buffer for buffering the reconstructed neighbor samples used by the first decoding process. The second processing circuit applies a second decoding process to the current coding block according to at least a portion of the reconstructed neighbor samples retrieved from the local neighbor buffer, wherein the second decoding process is different from the first decoding process.

### CROSS REFERENCE TO RELATED APPLICATIONS

This application claims the benefit of U.S. provisional application No. 63/238,859, filed on Aug. 31, 2021 and incorporated herein by reference.

### BACKGROUND

The present invention relates to a video decoder design, and more particularly, to a video decoder with hardware shared between different decoding circuits (e.g. an intra-prediction circuit and a chroma scaling circuit) and an associated video decoding method.

The Versatile Video Coding (VVC) standard (also known as H.266 standard) is the most recent video coding standard. The primary objective of the new VVC standard is to provide a significant increase in compression capability compared to its predecessor, the High Efficiency Video Coding (HEVC) standard (also known as H.265 standard). At the same time, VVC includes design features that make it suitable for a broad range of video applications. Like the HEVC standard, the VVC standard includes intra prediction, inter prediction, reconstruction, in-loop filters, etc. Compared to the HEVC standard, the VVC standard introduces many new coding tools. For example, the luma mapping with chroma scaling (LMCS) is a novel tool introduced in VVC that performs both luma mapping to the luma prediction signal in inter-prediction mode and chroma scaling to residuals after inverse transform and inverse quantization. In a conventional VVC/H.266 video decoder design, both of an intra-prediction circuit and a chroma scaling circuit obtain needed neighbor samples from an external frame-level buffer such as an off-chip dynamic random access memory (DRAM), and each of the intra-prediction circuit and the chroma scaling circuit has its own calculation function. Thus, there is a need for an innovative VVC/H.266 video decoder design with hardware shared between different decoding circuits (e.g. intra-prediction circuit and chroma scaling circuit).

### SUMMARY

One of the objectives of the claimed invention is to provide a video decoder with hardware shared between different decoding circuits (e.g. an intra-prediction circuit and a chroma scaling circuit) and an associated video decoding method.

According to a first aspect of the present invention, an exemplary video decoder is disclosed. The exemplary video decoder has a plurality of processing circuits, including a first processing circuit and a second processing circuit. The first processing circuit is arranged to apply a first decoding process to a current coding block according to reconstructed neighbor samples. The first processing circuit includes a local neighbor buffer arranged to buffer the reconstructed neighbor samples used by the first decoding process. The second processing circuit is arranged to apply a second decoding process to the current coding block according to at least a portion of the reconstructed neighbor samples retrieved from the local neighbor buffer, wherein the second decoding process is different from the first decoding process.

According to a second aspect of the present invention, an exemplary video decoding method is disclosed. The exemplary video decoding method includes performing a plurality of decoding processes, comprising: performing a first decoding process upon a current coding block according to reconstructed neighbor samples, wherein the first decoding process retrieves the reconstructed neighbor samples from a local neighbor buffer; and retrieving at least a portion of the reconstructed neighbor samples from the local neighbor buffer, and performing a second decoding process upon the current coding block according to at least a portion of the reconstructed neighbor samples, wherein the second decoding process is different from the first decoding process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating first video decoder architecture that adopts a hardware sharing technique for hardware cost reduction according to an embodiment of the present invention.

FIG. 2 is a diagram illustrating a first video decoder according to an embodiment of the present invention.

FIG. 3 is a block diagram illustrating second video decoder architecture that adopts a hardware sharing technique for hardware cost reduction according to an embodiment of the present invention.

FIG. 4 is a diagram illustrating a second video decoder according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

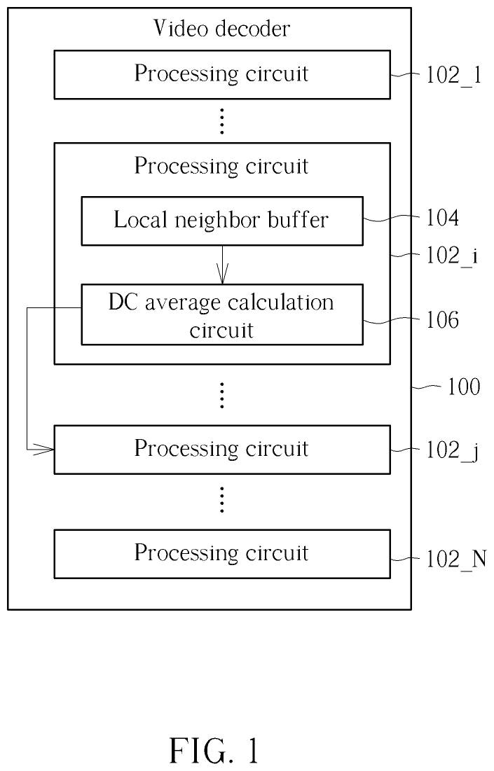

FIG. 1 is a block diagram illustrating first video decoder architecture that adopts a hardware sharing technique for hardware cost reduction according to an embodiment of the present invention. The video decoder 100 may be a VVC/H.266 decoder for decoding a bitstream in compliance with the VVC/H.266 standard. That is, the decoding processes performed by the video decoder 100 are in compliance with the VVC/H.266 standard. However, this is for illustrative purposes only, and is not meant to be a limitation of the present invention. In practice, any video decoder using the architecture proposed by the present invention falls within the scope of the present invention. The video decoder 100 includes a plurality of processing circuits 102_1-102_N (N>1) for dealing with designated decoding processes, respectively. As shown in FIG. 1, one processing circuit 102_i (1≤i≤N) includes a local neighbor buffer 104 and a direct current (DC) average calculation circuit 106. In this embodiment, the local neighbor buffer 104 may be a coding tree unit (CTU) level buffer (e.g. an on-chip static random access memory (SRAM)) that is much smaller than a frame level buffer (e.g. an off-chip DRAM). The local neighbor buffer 104 and the DC average calculation circuit 106 possessed by the processing circuit 102_i are both shared between the processing circuit 102_i and another processing circuit 102_j (1≤j≤N,j≠i). For example, the processing circuit 102_i is arranged to apply a first decoding process to a current coding block according to reconstructed neighbor samples. A coding block may be one coding unit (CU) consisting of one luma block and two chroma blocks. The local neighbor buffer 104 is arranged to buffer the reconstructed neighbor samples used by the first decoding process. The DC average calculation circuit 106 is arranged to calculate a first DC average value according to the reconstructed neighbor samples retrieved from the local neighbor buffer 104, where the first DC average value is used by the first decoding process. The processing circuit 102_j is arranged to apply a second decoding process to the current coding block according to at least a portion (e.g. part or all) of the reconstructed neighbor samples retrieved from the local neighbor buffer 104, where the second decoding process is different from the first decoding process. In this embodiment, the DC average calculation circuit 106 is shared for calculating a second DC average value according to at least a portion of the reconstructed neighbor samples retrieved from the shared local neighbor buffer 104, where the second DC average value is used by the second decoding process.

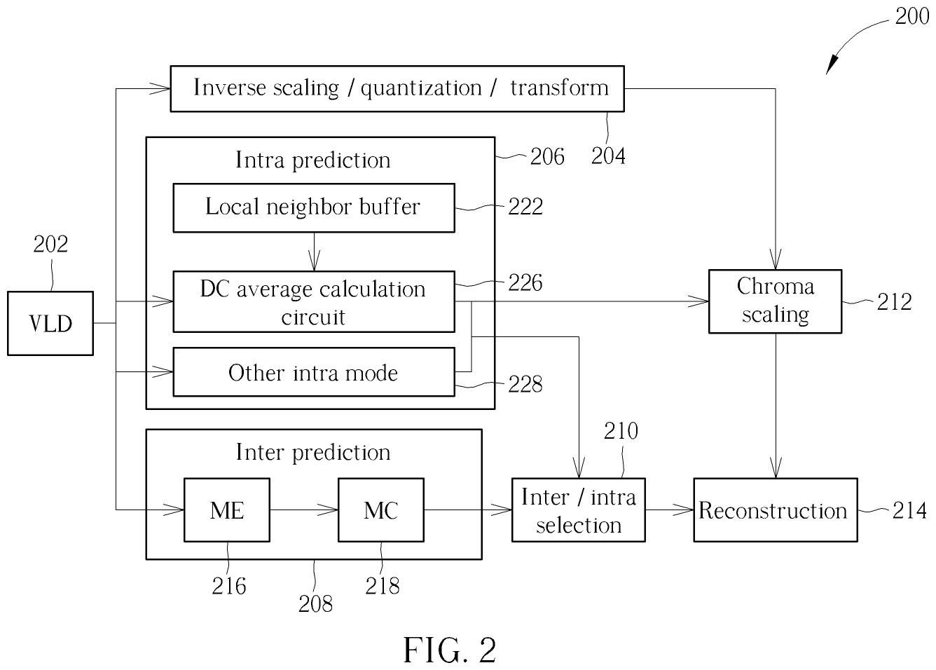

By way of example, but not limitation, one of the processing circuits 102_i and 102_j may be an intra-prediction circuit, and/or the other of the processing circuits 102_i and 102_j may be a chroma scaling circuit. FIG. 2 is a diagram illustrating a first video decoder according to an embodiment of the present invention. The video decoder 200 employs the video decoder architecture shown in FIG. 1, and therefore has a plurality of processing circuits, including an entropy decoder (e.g. variable length decoder (VLD) 202), an inverse scaling, quantization and transform circuit (labeled by “Inverse scaling/quantization/transform”) 204, an intra-prediction circuit (labeled by “Intra prediction”) 206, an inter-prediction circuit (labeled by “Inter prediction”) 208, an inter/intra mode selection circuit (labeled by “Inter/intra selection”) 210, a chroma scaling circuit (labeled by “Chroma scaling”) 212, and a reconstruction circuit (labeled by “Reconstruction”) 214.

The inter-prediction circuit 208 includes a motion estimation circuit (labeled by “ME”) 216 and a motion compensation circuit (labeled by “MC”) 218. In this embodiment, the processing circuit 102_i shown in FIG. 1 may be implemented by the intra-prediction circuit 206, and the processing circuit 102_j shown in FIG. 1 may be implemented by the chroma scaling circuit 212. Hence, the intra-prediction circuit 206 includes a local neighbor buffer 222, a DC average calculation circuit 226, and other intra-mode processing circuit (labeled by “Other intra mode”) 228, where the DC average calculation circuit 226 is used to deal with the DC mode in intra prediction. For brevity and simplicity, some decoder components, including in-loop filters, a decoded picture buffer (DPB), etc., are not shown in FIG. 2.

The intra-prediction circuit 206 is arranged to generate intra prediction samples of a current coding block according to reconstructed neighbor samples belonging to one or more neighbor coding blocks. The intra-prediction circuit 206 supports different intra prediction modes, including a DC mode. The DC mode is a traditional prediction mode in intra prediction. The concept of the DC mode is to predict each sample in a current coding block by an average of reconstructed neighbor samples. For example, when the DC mode is selected for intra prediction, each intra prediction sample of a current luma block is set by an average of reconstructed neighbor luma samples (e.g. top reconstructed neighbor luma samples, or left reconstructed neighbor luma samples, or top and left reconstructed neighbor luma samples).

The chroma scaling circuit 212 is arranged to use luma-dependent chroma residual scaling to compensate for luma-chroma interaction caused by luma mapping. The luma-dependent chroma residual scaling applies a constant scaling factor C_{ScaleInv} to all chroma residual samples C_{ResScale} in a chroma block, and may be expressed by C_{Res}=C_{ResScale}*C_{ScaleInv}. Derivation of the constant scaling factor Cscaieinv for a current chroma block relies on an average of reconstructed neighbor samples (e.g. top reconstructed neighbor luma samples, or left reconstructed neighbor luma samples, or top and left reconstructed neighbor luma samples). It should be noted that the reconstructed neighbor samples used by chroma sampling applied to a current coding block may be the same as the reconstructed neighbor samples used by DC mode intra prediction applied to the current coding block, or may be a subset of the reconstructed neighbor samples used by DC mode intra prediction applied to the current coding block.

Based on above observations, the present invention proposes applying the hardware sharing technique to the video decoder 200. Specifically, due to the algorithm similarity among DC mode intra prediction and chroma scaling, the local neighbor buffer 222 and the DC average calculation circuit 226 are both shared between the intra-prediction circuit 206 and the chroma scaling circuit 212. In this way, the hardware cost can be reduced.

The DC average calculation circuit 106/226 is not high-cost hardware. Compared to the DC average calculation circuit 106/226, the local neighbor buffer 104/222 costs more and needs more complex control technique. To simplify the complexity of the hardware control, the DC average calculation for DC mode intra prediction and the DC average calculation for chroma scaling may be independent of each other.

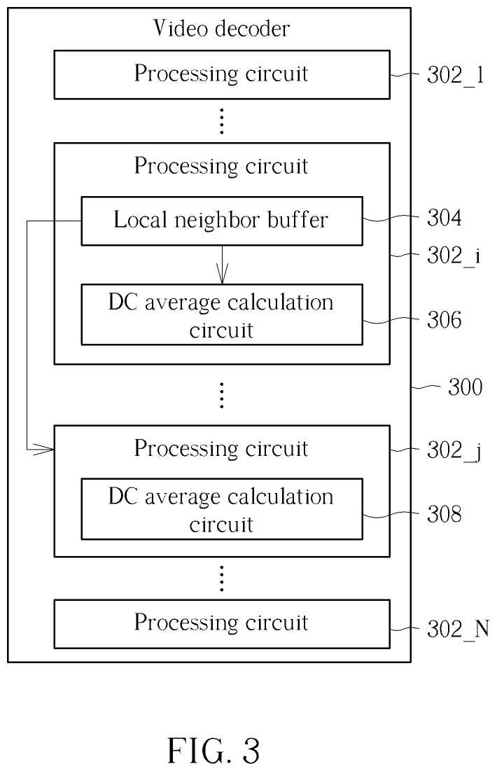

FIG. 3 is a block diagram illustrating second video decoder architecture that adopts a hardware sharing technique for hardware cost reduction according to an embodiment of the present invention. The video decoder 300 may be a VVC/H.266 decoder for decoding a bitstream in compliance with the VVC/H.266 standard. That is, the decoding processes performed by the video decoder 300 are in compliance with the VVC/H.266 standard. However, this is for illustrative purposes only, and is not meant to be a limitation of the present invention. In practice, any video decoder using the architecture proposed by the present invention falls within the scope of the present invention. The video decoder 300 includes a plurality of processing circuits 302_1-302_N (N>1) for dealing with designated decoding processes, respectively. As shown in FIG. 3, one processing circuit 302_i (1≤i≤N) includes a local neighbor buffer 304 and a DC average calculation circuit 306. In this embodiment, the local neighbor buffer 304 may be a CTU level buffer (e.g. an on-chip SRAM) that is much smaller than a frame level buffer (e.g. an off-chip DRAM). The local neighbor buffer 304 possessed by the processing circuit 302_i is shared between the processing circuit 302_i and another processing circuit 302_j (1≤i≤N,j≠i). Like the processing circuit 302_i, the processing circuit 302_j has its own DC average calculation circuit 308. In other words, the DC average calculation circuits 304 and 306 are individual circuits, such that the DC average calculation circuit 306 possessed by the processing circuit 302_i is not shared by the processing circuit 302_j.

In this embodiment, the processing circuit 302_i is arranged to apply a first decoding process to a current coding block according to reconstructed neighbor samples. For example, a coding block may be one CU consisting of one luma block and two chroma blocks. The local neighbor buffer 304 is arranged to buffer the reconstructed neighbor samples used by the first decoding process, and the DC average calculation circuit 106 is arranged to calculate a first DC average value according to the reconstructed neighbor samples retrieved from the local neighbor buffer 104, where the first DC average value is used by the first decoding process. The processing circuit 302_j is arranged to apply a second decoding process to the current coding block according to at least a portion (e.g. part or all) of the reconstructed neighbor samples retrieved from the local neighbor buffer 304, where the second decoding process is different from the first decoding process. The DC average calculation circuit 308 is used for calculating a second DC average value according to at least a portion of the reconstructed neighbor samples retrieved from the local neighbor buffer 304, where the second DC average value is used by the second decoding process.

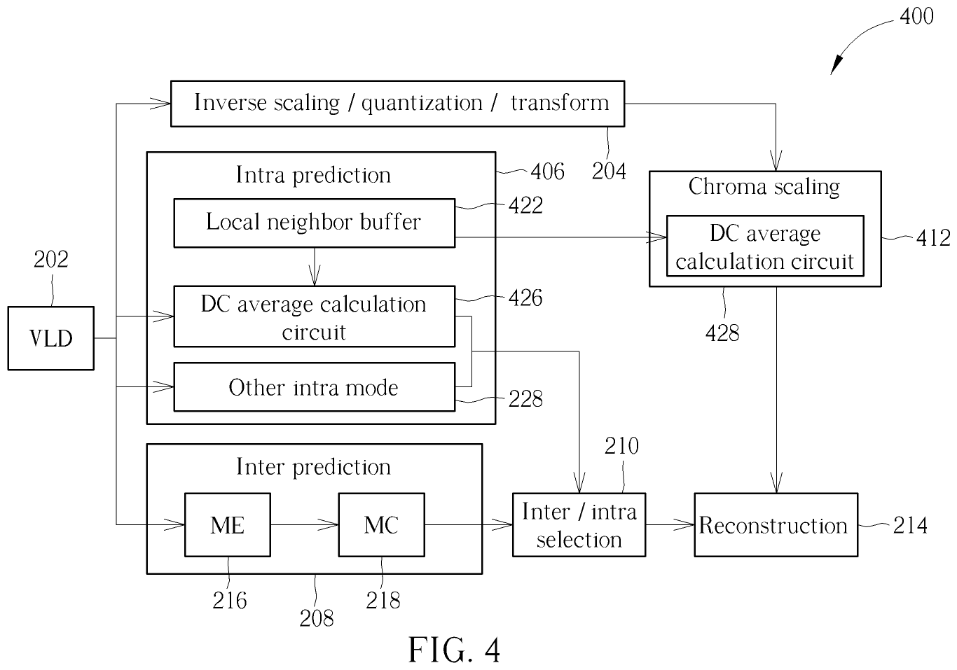

By way of example, but not limitation, one of the processing circuits 302_i and 302_j may be an intra-prediction circuit, and/or the other of the processing circuits 302_i and 302_j may be a chroma scaling circuit. FIG. 4 is a diagram illustrating a second video decoder according to an embodiment of the present invention. The video decoder 400 employs the video decoder architecture shown in FIG. 3. In this embodiment, the processing circuit 302_i shown in FIG. 3 may be implemented by the intra-prediction 406, and the processing circuit 302_j shown in FIG. 3 may be implemented by the chroma scaling circuit 412. For brevity and simplicity, some decoder components, including in-loop filters, a decoded picture buffer (DPB), etc., are not shown in FIG. 4. The major difference between video decoders 200 and 400 is the designs of the intra-prediction circuit 406 and the chroma scaling circuit 412. Regarding the intra-prediction 406, it includes a local neighbor buffer 422, a DC average calculation circuit 426, and other intra-mode processing circuit 228, where the DC average calculation circuit 426 is used to deal with DC mode in intra prediction, and the local neighbor buffer 422 is shared between the intra-prediction circuit 406 and the chroma scaling circuit 412 for buffering reconstructed neighbor samples used by DC mode intra prediction and chroma sharing. Regarding the chroma scaling circuit 412, it has a DC average calculation circuit 428 that is independent of the DC average calculation circuit 426 and used to deal with chroma scaling.

Specifically, the intra-prediction circuit 406 is arranged to generate intra prediction samples of a current coding block according to reconstructed neighbor samples belonging to one or more neighbor coding blocks. When a DC mode is selected for intra prediction, the DC average calculation circuit 426 retrieves reconstructed neighbor samples (e.g. top reconstructed neighbor luma samples, or left reconstructed neighbor luma samples, or top and left reconstructed neighbor luma samples) from the local neighbor buffer 422, and calculates an average of the reconstructed neighbor samples, where each intra prediction sample of a current luma block is set by the calculated average of the reconstructed neighbor samples.

The chroma scaling circuit 412 is arranged to use luma-dependent chroma residual scaling to compensate luma-chroma interaction caused by luma mapping. The DC average calculation circuit 428 retrieves reconstructed neighbor samples (e.g. top reconstructed neighbor luma samples, or left reconstructed neighbor luma samples, or top and left reconstructed neighbor luma samples) from the local neighbor buffer 422, and calculates an average of the reconstructed neighbor samples, where a constant scaling factor C_{ScaleInv} to be applied to all chroma residual samples C_{ResScale} in a chroma block is derived from the calculated average of the reconstructed neighbor samples. It should be noted that the reconstructed neighbor samples used by chroma sampling applied to a current coding block may be the same as the reconstructed neighbor samples used by DC mode intra prediction applied to the current coding block, or may be a subset of the reconstructed neighbor samples used by DC mode intra prediction applied to the current coding block.

Briefly summarized, since DC mode intra prediction and chroma scaling may employ same/similar algorithms for DC average calculation, one or both of a CTU level neighbor buffer and a DC average calculation circuit may be shared between DC mode intra prediction and chroma scaling, thereby reducing the hardware cost of a video decoder.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video decoder comprising:
a plurality of processing circuits, comprising:
a first processing circuit, arranged to apply a first decoding process to a current coding block according to reconstructed neighbor samples, wherein the first processing circuit comprises:
a local neighbor buffer, arranged to buffer the reconstructed neighbor samples used by the first decoding process; and
a second processing circuit, arranged to apply a second decoding process to the current coding block according to at least a portion of the reconstructed neighbor samples retrieved from the local neighbor buffer, wherein the second decoding process is different from the first decoding process.

2. The video decoder of claim 1, wherein the first processing circuit is an intra-prediction circuit.

3. The video decoder of claim 2, wherein the second processing circuit is a chroma scaling circuit.

4. The video decoder of claim 1, wherein the second processing circuit is a chroma scaling circuit.

5. The video decoder of claim 1, wherein the video decoder is a versatile video coding (VVC) decoder.

6. The video decoder of claim 1, wherein the first processing circuit further comprises:
a direct current (DC) average calculation circuit, shared between the first processing circuit and the second processing circuit, and arranged to calculate a first DC average value according to the reconstructed neighbor samples and calculate a second DC average value according to said at least a portion of the reconstructed neighbor samples;
wherein the first DC average value is used by the first decoding process, and the second DC average value is used by the second decoding process.

7. The video decoder of claim 6, wherein the first processing circuit is an intra-prediction circuit.

8. The video decoder of claim 7, wherein the second processing circuit is a chroma scaling circuit.

9. The video decoder of claim 6, wherein the second processing circuit is a chroma scaling circuit.

10. The video decoder of claim 6, wherein the video decoder is a versatile video coding (VVC) decoder.

11. A video decoding method comprising:
performing a plurality of decoding processes, comprising:
performing a first decoding process upon a current coding block according to reconstructed neighbor samples, wherein the first decoding process retrieves the reconstructed neighbor samples from a local neighbor buffer; and
retrieving at least a portion of the reconstructed neighbor samples from the local neighbor buffer, and performing a second decoding process upon the current coding block according to said at least a portion of the reconstructed neighbor samples, wherein the second decoding process is different from the first decoding process.

12. The video decoding method of claim 11, wherein the first decoding process is an intra-prediction process.

13. The video decoding method of claim 12, wherein the second decoding process is a chroma scaling process.

14. The video decoding method of claim 11, wherein the second decoding process is a chroma scaling process.

15. The video decoding method of claim 11, wherein the plurality of decoding processes comply with a versatile video coding (VVC) standard.

16. The video decoding method of claim 11, wherein performing the first decoding process upon the current coding block according to the reconstructed neighbor samples comprises:
calculating, by a direct current (DC) average calculation circuit,
a first DC average value according to the reconstructed neighbor samples, wherein the first DC average value is used by the first decoding process; and
performing the second decoding process upon the current coding block according to said at least a portion of the reconstructed neighbor samples comprises:
calculating, by a direct current (DC) average calculation circuit,
a second DC average value according to said at least a portion of the reconstructed neighbor samples, wherein the second DC average value is used by the second decoding process, and the DC average calculation circuit is shared between the first decoding process and the second decoding process.

17. The video decoding method of claim 16, wherein the first decoding process is an intra-prediction process.

18. The video decoding method of claim 17, wherein the second decoding process is a chroma scaling process.

19. The video decoding method of claim 16, wherein the second decoding process is a chroma scaling process.

20. The video decoding method of claim 16, wherein the plurality of decoding processes comply with a versatile video coding (VVC) standard.
